(19) United States
(12) Patent Application Publication
(10) Pub. No.: US 2009/0271906 A1
(43) Pub. Date: Nov. 5, 2009

(54) Finger Training Apparatus

(76) Inventor: Robert Matthew Lee, Elmhurst, IL (US)

Correspondence Address: WHITING TECHNOLOGIES CORPORATION, 646 EXECUTIVE DRIVE, WILLOWBROOK, IL, 60527, US

(21) Appl. No.: 12/426,793

(22) Filed: Apr. 20, 2009

Related U.S. Application Data
(60) Provisional application No. 61/049,629, filed on May 1, 2008.

(51) Int. Cl. A41D 13/08; A41D 19/00; G09B 15/06

(52) U.S. Cl. 2/21; 2/163; 84/465

(57) ABSTRACT

A finger training apparatus comprising a glove with anchors attached to one or more fingertips and detachably fastened to keys, buttons, or valves of a musical instrument, controller, or handheld device to prevent slippage of the operator's fingers in order to train the operator to maintain proper finger positioning.

### FIELD OF THE INVENTION

The present invention relates to any device requiring fixed finger positioning in order to maximize the efficiency of operation. Such devices include musical instruments such as trumpets or other wind instruments, specialized keyboards or controllers, or other handheld devices requiring each of the operator's fingers to be operating the same key, button, or valve at all times.

### BACKGROUND OF THE INVENTION

Proper finger positioning on a device's keys, buttons, or valves is typically essential when learning to operate the device. Moreover, inexperienced operators may suffer from slippage of the fingers and excessive finger motion, often resulting in improper operation of the device and leading to poor technique and lack of efficiency. The present invention is intended to train the operator to use proper fingering by fastening his or her fingers to the device in the correct operating position.

For example, a trumpet is such a device requiring proper finger positioning, and will be referenced in the following descriptions and drawings.

### SUMMARY

The present invention includes a glove which assists in training the fingers of an operator of a handheld device, such as a musical instrument, to properly operate the device by maintaining desired finger positioning through constant contact between the fingers and the keys, buttons, or valves.

The invention is comprised of a glove having one or more attached fingers. On the tip of one or more of the fingers, half of an anchor is attached. The anchor is comprised of the hook portion of a hook and loop fastener, a magnet, or any other detachable fastener. The remaining half of the anchor is comprised of the loop portion of a hook and loop fastener, a magnet of opposite polarity to that attached to the finger(s), or any other detachable fastener. The fingertips are then attached to the keys, valves, or buttons of the handheld device by joining the halves of the aforementioned detachable fasteners. Thus, the operator's fingers are prevented from slipping or coming out of contact with the keys, buttons, or valves. Repeated use of the training apparatus allows the operator to develop proper finger positioning through muscle memory.

### BRIEF DESCRIPTION OF THE DRAWINGS

FIG. 1 is a view of the palm side of any device capable of fastening to the operator's fingertips. Anchors are attached to the fingertips of the finger device as described by the invention. The finger device is represented by a glove in FIG. 1. Rather than a glove, the finger device could consist of individual finger cots, bands, or any other means to mount anchors and subsequent attachments to the fingertips.

FIG. 2 is a plan view of a device requiring proper finger positioning, in this case a typical trumpet, depicting the locations of the anchor attachments adhered to the finger buttons.

FIG. 3 is a side view showing the apparatus, which includes the finger device and the attached anchors, fastened to anchor attachments adhered to the finger buttons of a typical trumpet.

### PREFERRED EMBODIMENT OF THE PRESENT INVENTION

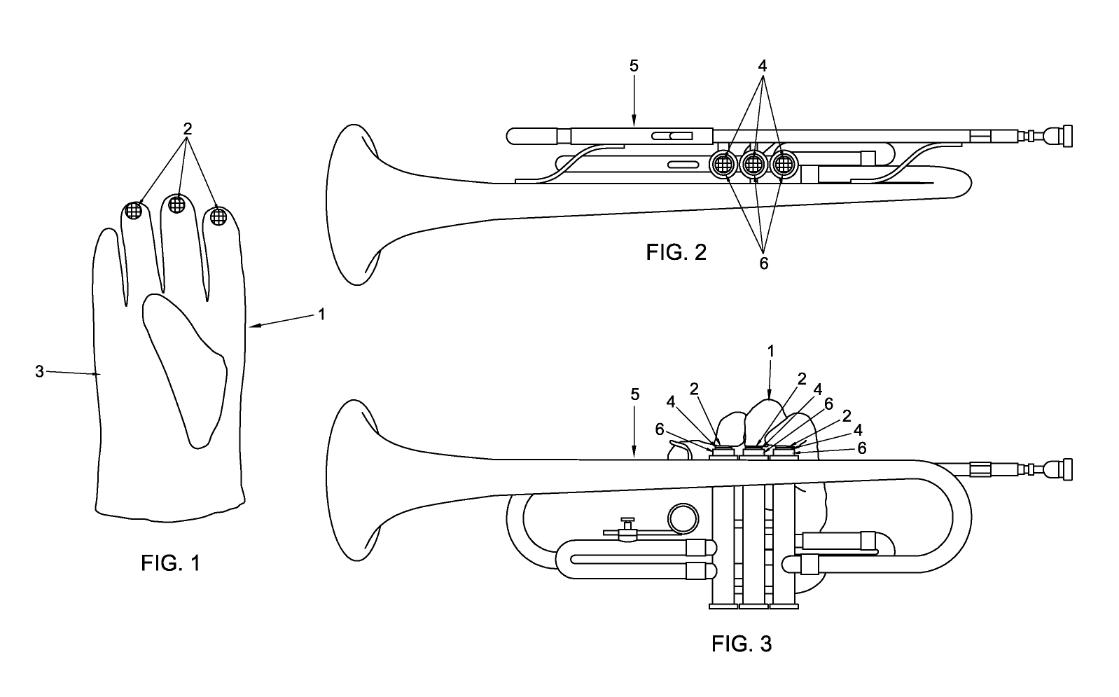

Referring to FIG. 1, a finger training apparatus assembly generally designated 1 is shown. Anchors 2 are attached to the fingertips of the device 3, typically but not exclusively on the palm side. The number of fingers requiring anchors depends on the number of finger-operated keys, buttons, or valves on the device. FIG. 1 depicts a finger training apparatus 1 used for a device with three finger-operated keys, buttons, or valves, in this case a trumpet. The anchors 2 are constructed of a detachable fastening means such as a magnet, the hook portion of a hook and loop fastener, or any other detachable fastening means, and are adhered to the finger device 3 by way of an adhesive, stitching, or other adhesion means.

FIG. 2 depicts a device, such as a trumpet, generally designated 5. Anchor attachments 4 are fastened to the finger-operated keys, buttons, or valves 6, with an adhesive or other adhesion means. The anchor attachments 4 are constructed such that they detachably fasten to anchors 2 on the finger training apparatus 1 using a mating fastening means. Such a means includes a magnet opposite in polarity to that used for anchors 2, a loop portion of a hook and loop fastener, or any other detachable mating fastening means.

Referring to FIG. 3, finger training apparatus 1 is shown attached to trumpet 5 with anchors 2 and anchor attachments 4. As previously described, anchor attachments 4 are attached to finger buttons 6 using an adhesive or other adhesion means. When the operator uses the finger training apparatus 1 as shown, his or her fingers will remain in the desired operating position on finger-operated keys, buttons, or valves 6. Once the operator is finished training, anchor attachments 4 may be removed to expose finger-operated keys, buttons, or valves for normal use.

What is claimed:

1. A finger training apparatus comprising a glove with one or more glove fingers, or individual finger cots, having anchors adhered to the tip of one or more of said glove fingers or finger cots.

2. The finger training apparatus as described in claim 1 wherein tips of said glove fingers or finger cots are detachably fastened to keys, buttons, or valves of a handheld device by means of anchors, said anchors comprising hook and loop fasteners, magnets, or any other detachable fasteners being attached on one side to the tips of said glove fingers or finger cots by means of stitching, adhesive, or other adhesion means and attached on remaining side to said keys, buttons, or valves by means of adhesive or other adhesion means.

3. The finger training apparatus as described in claim 2 wherein said anchors may be separated, leaving half of said anchor, such as the hook portion of a hook and loop fastener, attached to said glove fingers or finger cots, and remaining half of said anchor, such as the loop portion of a hook and loop fastener, attached to said keys, buttons, or valves of a handheld device, thus detaching said glove fingers from said keys, buttons, or valves.
